(19) United States
(12) Patent Application Publication
(10) Pub. No.: US 2006/0104687 A1
(43) Pub. Date: May 18, 2006

(54) System for copying onto tab stock

(75) Inventors: David R. Campbell, Rochester, NY (US); Kimberly S. Stankey, Rochester, NY (US); Erika Christian Dabney, Rochester, NY (US); John A. Sklenar, Rochester, NY (US); John A. Bursie, Rochester, NY (US); Murray O. Meetze, JR., Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/987,060

(22) Filed: Nov. 12, 2004

(51) Int. Cl. G03G 15/00

(52) U.S. Cl. 399/394

(57) ABSTRACT

A copier includes an input scanner for recording images from an input sheet moving in an input process direction, yielding image data, and a print engine for printing an image based on the image data on an output sheet moving in an output process direction. The input sheet is fed through the input scanner with an image for a tab near a lead edge thereof. An output sheet having a tab relative to the print engine is fed so the tab is on a trail edge thereof. An image formed by the output sheet is displaced toward the trail edge of the output sheet by a predetermined length.

### TECHNICAL FIELD

The present disclosure relates to office equipment such as copiers, and in particular relates to copying images onto tab stock.

### BACKGROUND

“Tab stock” is familiarly used to separate sections of multipage documents, as would be bound, for example, in ring binders or comb binders. An individual page of tab stock includes a tab extending from one edge of the sheet, and text can be printed on the tab. A page of tab stock typically has a total width greater than that of the paper with which it is used; for instance, for use in a book made from 8½×11 inch (letter-size) sheets, a suitable piece of tab stock will have a width of about nine inches, of which 8½ inches corresponds to the regular width of the sheets, plus an extra half inch associated with the tab.

In printing or copying multipage documents with tab stock (copying for present purposes being a type of printing), a printer must take into account the different widths of the tab stock and accompanying “regular” sheets so that the desired text is correctly placed on each tab. Because the tab is located in effect outside the image area for a regular sheet, a system must be devised so that the text is reliably placed on the tab; such a system should also smoothly integrate the printing of tab stock with the printing of regular sheets.

U.S. Pat. No. 5,210,622 discloses a printer/copier system in which tab stock is printed on by means of a “variable image shift.” However, the amount of image shift required to place selected text on a tab must be entered, or at least selected as default, by the human user.

### SUMMARY

According to one aspect, there is provided a method of operating a copier including an input scanner for recording images from an input sheet moving in an input process direction, yielding image data, and a print engine for printing an image based on the image data on an output sheet moving in an output process direction. The input sheet is fed through the input scanner with an image for a tab near a lead edge thereof. An output sheet having a tab relative to the print engine is fed so a tab on the output sheet is on a trail edge thereof. An image formed by the output sheet is displaced toward the trail edge of the output sheet by a predetermined length.

According to another aspect, there is provided a method of operating a print engine, comprising feeding a sheet of tab stock in a process direction relative to the print engine, so that a tab of the tab stock is disposed at a trail edge of the tab stock. The print engine places a standard-size image on the tab stock. Extra image data is added to the standard-size image, at a location of the standard-size image corresponding to a lead edge of the tab stock along the process direction, thereby displacing the standard-size image so that at least a portion of the standard-size image is placed on the tab of the tab stock.

### BRIEF DESCRIPTION OF THE DRAWINGS

FIG. 1 is a perspective view showing some elements of a digital copier.

FIG. 2 is a view of an input scanner and a photoreceptor showing how an image fed past the input scanner, processed as digital data, and then placed on the photoreceptor is disposed on tab stock.

### DETAILED DESCRIPTION

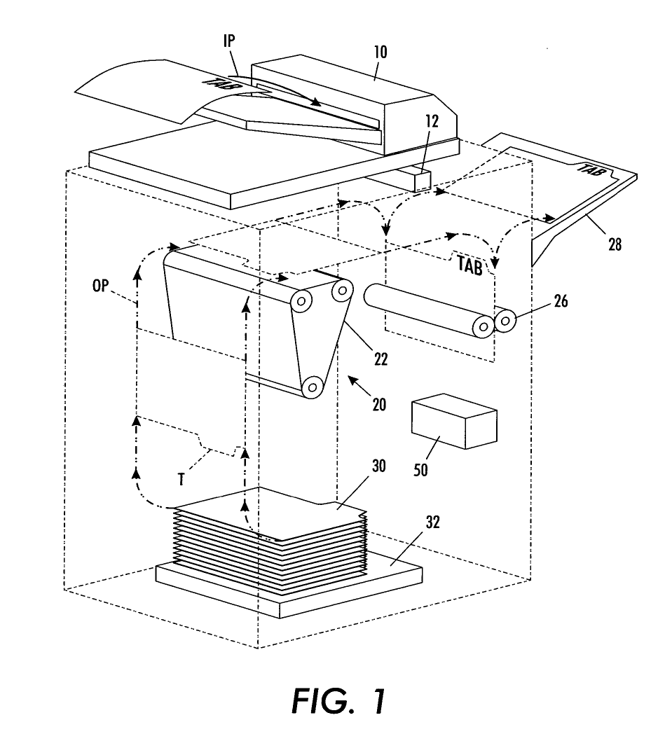

FIG. 1 is a perspective view showing some elements of a digital copier. The digital copier accepts original images on input sheets fed through a document handler generally indicated as 10. Input sheets fed in succession through document handler 10 pass over an input scanner 12, which records light from a series of small areas on each input sheet, yielding digital image data, in a manner generally familiar in the art. Because the input sheets move relative in an input process direction IP to the input scanner 12, there can be said to be a “lead edge” associated with each input sheet, meaning the first edge “seen” by the input scanner 12. In this embodiment, a lead edge of an input sheet can be deemed a “first line” of a raster for reckoning image data recorded by the image scanner 12.

In a digital copier, there is also a print engine, here generally indicated as 20. In this embodiment, which is a xerographic printer, the print engine 20 includes a rotatable image receptor, such as electrostatographic photoreceptor 22, on which images are created and subsequently transferred, in a manner generally familiar in the art (typical elements associated with xerography, such as development, exposure, transfer and cleaning stations, are not shown).

Output sheets, on which images are placed by the print engine 20, are initially placed in one of a set of paper supply stacks, from which they are drawn one at a time. One such paper supply stack is indicated as 30, although there are typically other stacks available for feeding into the print engine 20, each with a paper supply of a predetermined type. Paper supply stack 30 here includes “tab stock,” meaning, in this embodiment, sheets which have general dimensions similar to regular stock (such as letter, tabloid, A3, A4, etc.) but in addition have a tab T defined along one edge thereof. The tab T effectively increases the dimension of the tab stock, relative to a corresponding dimension in the regular stock: to take one example, for use in a book made from 8½×11 inch sheets, a suitable piece of tab stock will have a width of about nine inches, of which 8½ inches corresponds to the regular width of the sheets, plus an extra half inch associated with the tab.

As shown in FIG. 1, the stack 30 of tab stock is placed in a drawer or tray 32 in such a way that, when a sheet of tab stock is drawn from stack 30 and passed through print engine 20 along an output process direction OP, the tab on the sheet is disposed at the trail edge of the sheet. After the sheet passes out of the print engine 20, the sheet can be inverted in an inverter 26, which causes the tab stock to be flipped over so that the tab is at a lead edge as the sheet moves to output tray 28 (or into a finishing device, such as a stapler, stacker or booklet maker, not shown). The inverter 26, in the illustrated embodiment, also causes the image placed on the tab stock by photoreceptor 22, which is face-down when transferred to the sheet, to be face-up.

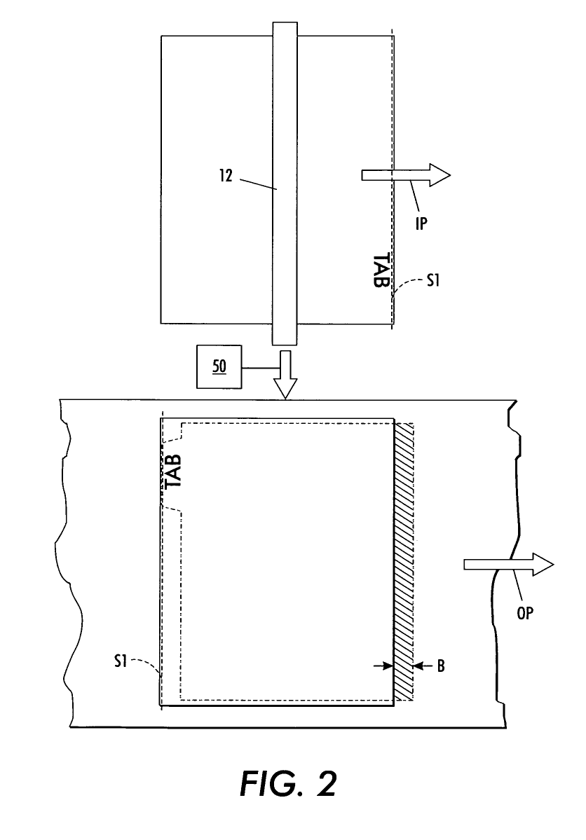

FIG. 2 is a view of the input scanner 12 within document handler 10 and the photoreceptor 22 (each in effect “flattened out” to ignore bends in the paper path or the rollers on which the photoreceptor is entrained) showing how an image fed past the input scanner 12, processed as digital data, and then placed on the photoreceptor 22 and transferred by contact with an output sheet is disposed on tab stock. In this example, an input sheet of regular dimensions such as letter or A4 (that is, not tab stock) includes an image (in this case the word TAB) near the lead edge thereof that is sized and positioned to be located on a tab in a resulting copy on tab stock. When the original image is recorded by input scanner 12, the image is in effect “reckoned” relative to the lead edge of the sheet: a first scanline of image data relative to the lead edge of the original image is indicated in FIG. 2 as S1. The pixels forming the image are organized relative to the first scanline S1, which at least roughly corresponds to the lead edge of original sheet being fed. As used herein, the basic image fed into the document handler 10 on standard-size paper (not tab stock) can be considered the “standard-size image” which is submitted, in digital form, to the print engine (notwithstanding any manipulation, including reduction or enlargement of the scanned image, of the image data that does not effect the basic size of the output image).

To reproduce the image derived from the non-tab-stock input sheet onto a tab-stock output sheet so that the image is placed on the tab of the output sheet, in the architecture of FIG. 1 it is seen that the tab on the output sheet is on the trail edge of the output sheet as it passes through the print engine 20 and contacts photoreceptor 22. Because the tab stock is slightly wider than corresponding regular stock, it is longer along the output process direction OP than regular stock. In order to place the image on the tab of the output sheet, the original image, which has the same width as the original image, must be displaced relative to the output sheet, so the image is not placed on the body of the output sheet but rather on the extra width associated with the tab. However, because the trail edge of the output sheet corresponds to the lead edge of the input sheet, the position of the image intended for the tab is reckoned or fixed relative to the trail edge of the output sheet, which corresponds to the outer edge of the tab.

To perform this displacement, according to one embodiment, the image from input scanner 12 is buffered or “padded” by the addition of image data, such as in the form of scanlines of white or blank pixels, that extends the length of the image along output process direction OP by a fixed amount. This fixed amount corresponds approximately to the additional length along OP provided to tab stock by the tab T. However, the image data is added to the side of the printed image which is opposite that of the lead edge of the data, where the image to be placed on the tab (the image TAB in this example) is located. As can be seen in FIG. 2, the first scanline S1 in the original image going past scanner 12 is located on the trail edge (along direction OP) of the printed image on photoreceptor 22. Because the lead edge of the original image recorded by input scanner 12 corresponds to the trail edge of the output sheet contacting photoreceptor 22, the text (the word TAB) remains a fixed distance from the first scanline S1 at the trail edge of the output image on the photoreceptor 22, and thus is placed correctly on the tab T. The extra image data, adding the extra length to the image along the OP direction, is in effect added to the trail end of the data forming the page-sized image; but since the trail end of the image data is the lead edge of the image being created along direction OP, the text intended to be placed on the tab is in effect pushed “backward” along direction OP at the trail edge, and is thus placed correctly on tab T.

In one embodiment, the extra data corresponding to the buffer is added to a page image whenever tab stock is detected as being drawn from a drawer or stack in the copier. This cause and effect can be set up when only tab stock is being printed on in a job, or when tab stock is intermixed with regular-sized stock within a job. In one possible embodiment, if it is known in advance that a certain paper tray or drawer such as 32 contains tab stock, the extra image data will be added to the output image as a result of a sheet of tab stock being drawn from that drawer. All of the displacement and ancillary functions can be carried out through a control system 50 associated with the digital copier, which is shown generally in FIGS. 1 and 2. The control system 50 can have software and/or hardware aspects, can be part of a general control system governing the entire machine, and can interact with entities external to the copier.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A method of operating a copier, the copier including an input scanner for recording images from an input sheet moving in an input process direction, yielding image data, and a print engine for printing an image based on the image data on an output sheet moving in an output process direction, comprising:
feeding the input sheet through the input scanner with an image for a tab near a lead edge thereof;
feeding an output sheet having a tab relative to the print engine so the tab on the output sheet is on a trail edge thereof; and
displacing an image formed by the print engine toward the trail edge of the output sheet by a predetermined length.

2. The method of claim 1, wherein the input sheet has a dimension of a standard-size sheet, and the output sheet has a dimension of a standard-size sheet plus a length of a tab.

3. The method of claim 1, wherein the image data is reckoned from a first scanline associated with a lead edge of the input sheet.

4. The method of claim 3, wherein the displacing is a result of adding image data to the input data corresponding to an edge of the image opposite the first scanline.

5. The method of claim 4, wherein the added image data substantially consists of white pixels.

6. The method of claim 1, the displacing being a result of drawing an output sheet having a tab from a paper supply.

7. The method of claim 1, further comprising
inverting the output sheet after the output sheet leaves the print engine.

8. The method of claim 1, wherein the print engine includes a rotatable electrostatographic image receptor.

9. A method of operating a print engine, comprising:
feeding a sheet of tab stock in a process direction relative to the print engine, so that a tab of the tab stock is disposed at a trail edge of the tab stock;
causing the print engine to place a standard-size image on the tab stock; and
adding extra image data to the standard-size image, at a location of the standard-size image corresponding to a lead edge of the tab stock along the process direction, thereby displacing the standard-size image so that at least a portion of the standard-size image is placed on the tab of the tab stock.

10. The method of claim 9, wherein the extra image data displaces the standard-size image by a distance approximately equal to a length of the tab.

11. The method of claim 9, wherein the extra image data substantially consists of white pixels.

12. The method of claim 9, the print engine including a rotatable image receptor.

13. The method of claim 12, the image receptor being an electrostatographic charge receptor.

14. The method of claim 8, further comprising
scanning an original image to obtain digital image data corresponding to the standard-size image.

15. The method of claim 8, the displacing being a result of drawing an output sheet having a tab from a paper supply.

16. The method of claim 15, further comprising
detecting drawing tab stock from a paper supply.

17. The method of claim 8, further comprising
inverting the tab stock after the tab stock leaves the print engine.
